(19) United States
(12) Patent Application Publication
(10) Pub. No.: US 2014/0217018 A1
(43) Pub. Date: Aug. 7, 2014

(54) Biological Nitrogen Removal Aeration Control

(71) Applicants: Keith Dobie, Humarock, MA (US); Philip B. Pedros, Wakefield, MA (US); Andrew R. McBrearty, Milton, MA (US)

(72) Inventors: Keith Dobie, Humarock, MA (US); Philip B. Pedros, Wakefield, MA (US); Andrew R. McBrearty, Milton, MA (US)

(21) Appl. No.: 13/757,746

(22) Filed: Feb. 2, 2013

(51) Int. Cl. C02F 3/02

(52) U.S. Cl. CPC C02F 3/02
USPC 210/614; 210/621

(57) ABSTRACT

A biological reactor which is intermittently aerated to create an environment that alternates from aerobic to anoxic. A programmable logic controller controls the amount and timing of air flow to the biological reactor linking aeration to incoming load.

### CROSS-REFERENCE TO RELATED APPLICATIONS

Applicants claim the priority benefits of U.S. Provisional Patent Application No. 61/594,081, filed Feb. 2, 2012.

### BACKGROUND OF THE INVENTION

This invention relates to waste treatment systems, and in particular, to a method for removing both carbonaceous matter and nitrogen from wastewater.

Biological removal of nitrogen from wastewater is a multi-step process and is fairly complex. Nitrogen, in different forms, is a component of many of the molecules present in wastewater. Some examples of nitrogen-based molecules include ammonium, urea and proteins. Removal of nitrogen occurs through biochemical transformations mediated by multiple types of microorganisms, for example ammonification occurs during the oxidation of organic material containing nitrogenous compounds. As soluble organic matter is oxidized, nitrogen bound compounds, such as amines (NH₂⁻) are released and bond with H⁺ ions forming ammonia or ammonium.

Removal of the ammonia and ammonium forms of nitrogen from wastewater streams is a two-step process. In the first step the oxidation of ammonium to nitrate (nitrification) is accomplished by the aerobic growth of chemolithotrophic, autotrophic bacteria in an aerobic environment. Nitrification occurs only when the quantity of organic carbonaceous matter has been reduced according to the well-established criterion for the transition from oxidation of organics to nitrification, within the biofloc. See, e.g., Williamson and McCarty 1976, Owen and Williamson 1976, Riemer 1977, Harremoës 1982, Harremoës and Gönenc 1985.

In the second step organic carbonaceous matter (organics) is oxidized by the growth of heterotrophic bacteria utilizing nitrate as the terminal electron accepter (i.e. denitrification). The nitrate is converted to nitrogen gas (N₂) and released to the atmosphere. The equation describing the biochemical transformation depends on the organic carbon source utilized. The following is the mass based stoichiometric equation, normalized with respect to nitrate, with the influent waste stream as the organic carbon source (Water Environment Federation 1998).

NO₃⁻+0.324 C₁₀H₁₉O₃N>0.226 N₂+0.710 CO₂+0.087 H₂O+0.027 NH₃+0.274 OH⁻

This results in the removal of nitrogen from the wastewater stream by releasing gaseous nitrogen.

One of the complexities in this process is that, some of the organic matter must be removed before nitrification can occur; however, organic matter is required for denitirfication. The inventors have countered this problem in their prior art processes by providing a biological reactor, which grows a biomass on media within the reactor. The reactor is intermittently aerated to create an environment that alternates from aerobic to anoxic. The term, anoxic, means an environment in which respiration with nitrate as the terminal elector is available. The prior art biological reactor processes did not regulate air flow to the reactor.

If the goal is to remove nitrogen within one reactor, the quantity of air supplied is very important. Too little air inhibits nitrification and too much air inhibits denitrification. With respect to air, the most effective way to achieve nitrogen removal is to supply just air sufficient for nitrification. To this end a process by which the quantity of air supplied to the reactor is paced according to the influent flow, carbon (as measured by BOD₅) and nitrogen is required. The mass of air supplied to the biological reactor is determined by an aeration factor (AF) that accounts for influent flow and both the BOD₅ and TKN concentrations.

BOD stands for biological oxygen demand, also known as biochemical oxygen demand. BOD represents the amount of oxygen required by aerobic microorganisms ti decompose the organic matter in a sample of water, such as that polluted by sewage. It is used as a measure of the degree of water pollution. TKN stands for total kjeldahl nitrogen which is the sum of organic nitrogen, ammonia and ammonium in wastewater, e.g., sewage treatment plant effluent.

### SUMMARY OF THE INVENTION

Prior art wastewater treatment systems basically comprised of an anoxic tank outputting to a biological reactor and outputting from the reactor to a clear well are known. The present invention provides a major improvement to prior art wastewater treatment systems by controlling the amount and timing of air flow to the biological reactor using a programmable logic controller (PLC) to link the aeration to the incoming load.

Two different environments are required for nitrification and denitrification: an aerobic environment for nitrification and an anoxic environment for denitrification. These environments can be maintained within the present invention process. Because of the aerobic and anoxic environmental conditions required the biological reactor is intermittently aerated, by running the blower for some “ON” time and then shut off for some period of time called the “OFF” time. A programmable logic controller automatically calculates the “ON” and OFF” times, based on what enters the system. The influent flow is measured indirectly by monitoring the run time of a specific piece of equipment. The concentrations of BOD₅ and nitrogen are accounted for in the aeration factor. Input of an aeration factor of 100 means that the system will deliver the quantity of air required for a plant's design load. Essentially, this number determines the minutes of air per gallon of flow that must be supplied to the biological reactor, i.e., the mass of air required. The details of the program are described below.

These together with other objects of the invention, along with various features of novelty, which characterize the invention, are pointed out with particularity in this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a graph showing minutes of process air required per gallon of flow.

FIG. 2 illustrates a process control dialog.

FIG. 3 is a process air control graph showing the effects of Aeration Factor changes.

FIG. 4 is a block diagram of a wastewater treatment system used in the present invention biological nitrogen removal feed process.

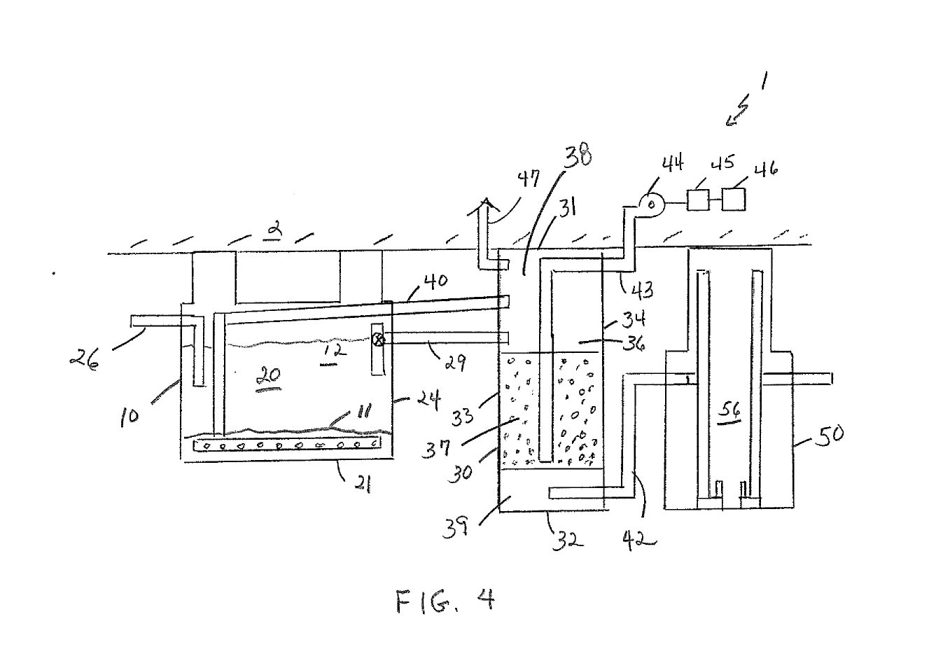

### DETAILED DESCRIPTION OF INVENTION

Referring to the drawings in detail wherein like elements are indicated by like numerals, there are shown a process flow for a typical wastewater treatment system 1, and the invention process installed in the biological reactor portion of the wastewater treatment system 1.

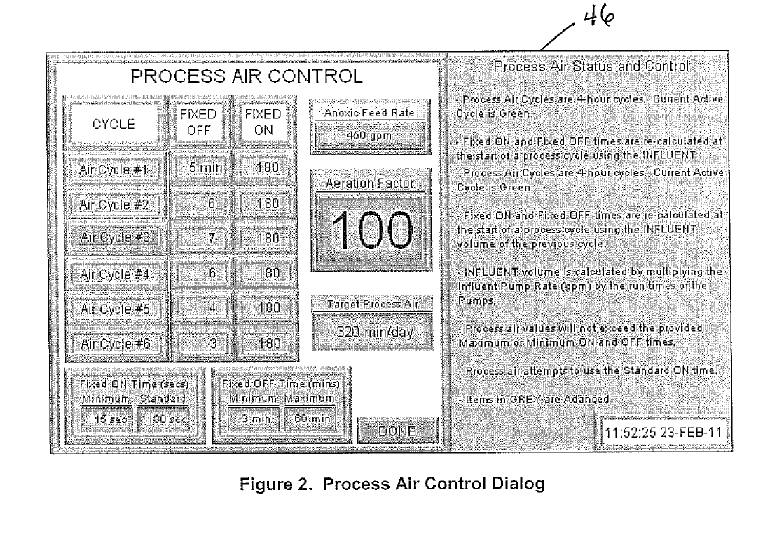

The wastewater treatment system 1 has an anoxic tank 10 outputting to a biological reactor 30 and outputting from the reactor to a clear well 50. The anoxic tank typically provides primary treatment for wastewater. The anoxic tank has an output pipe 29 for anoxic tank effluent 12. The biological reactor 30 has a top 31, a bottom 32, receiving side 33, discharge side 34, two opposite side walls interconnecting the receiving and discharge sides, said top, bottom, receiving side, discharge side and side walls defining a reactor interior 36. The reactor interior 36 has a filter media 37, an open head-space 38 above the filter media, and a sump 39 formed beneath the filter media and above the reactor bottom 32. The anoxic tank output pipe 29 connects to the biological reactor 30 and brings the anoxic tank effluent 12 to the biological reactor interior head-space 38 just above the reactor filter media 37. The biological reactor 30 has a recycle pipe 40 interconnecting the biological reactor interior head-space 38 with the anoxic tank interior 20. The biological reactor 30 has a discharge pipe 42 interconnecting the biological reactor sump 39 with a clear well interior 56. An air pipe 43 is inserted into the biological reactor interior 36 near to the reactor top 31, and through the filter media 37. The air pipe 43 is connected to an air source 44, such as an air pump and/or blower, on the ground surface 2, said air pump/blower 44 is controlled by the PLC 45 via the control panel shown 46 in FIG. 2. During an aeration cycle, air is pumped into the air pipe 43. Oxygenation is provided to the biological reactor interior 36 while air is being pumped into the air pipe 43.

Raw untreated sewage wastewater having a significant concentration of waste solids is introduced into the anoxic tank interior 20 through the anoxic tank input pipe 26. Solids having a higher density than liquid sink to the tank bottom 21 to form a sludge layer 11. The liquid portion of the wastewater, which exits the anoxic tank discharge end 24 by means of gravity, a pump, or a siphon, is the anoxic tank effluent 12. The anoxic tank effluent 12 is brought into the biological reactor 30 for treatment in an aerobic environment allowing different types of bacteria to oxidize the carbonous matter and ammonia nitrogen to nitrate nitrogen. By then treating the effluent in an anoxic environment, the nitrified wastewater is denitrified and the nitrogen gas formed is released to the atmosphere through a vent pipe 47 while the treated wastewater, with a lower level of nitrogen compounds, is returned to the receiving stream or to the clear well 50 and then discharged to the environment.

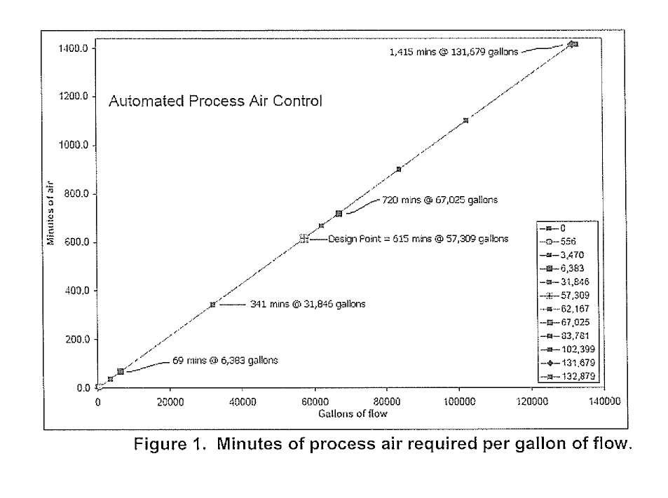

The invention process is as follows. The biological reactor is aerated. Following the aeration cycle, the air blower is shut off and a blower off period is entered. The blower off period allows time for nitrification to continue until the dissolved oxygen is consumed, after which denitrification will occur. The process periodically re-calculates the “ON” and “OFF” times based on the flow, and the air that has already been placed into the system during the previous cycle. The number of Process Cycles in a 24-hour period is adjustable. The ON OFF times (process air) are re-calculated at the start of every new Process Cycle. The volume of wastewater (“Volume to Treat”) is determined from one of the following: 1) Influent Pumps; 2) Plus Feed Pumps; or 3) Final Effluent Pumps. The equipment is listed in order of preference. If a pump (e.g. influent pump) does not exist, then the next pump in order is used. The “Total Process Air” required in 24 hours for the given “Volume to Treat” is from the slope of the line, as shown in FIG. 1.

The slope of the line for each system is calculated based on the assumed influent load (BOD, TKN), the reactor volume and process air delivered. For the system shown, at the design flow of 57,309 gpd, a total of 615 minutes of process air (i.e. a slope of 0.0107 minutes/gallon) would be required over the next 24 hours. The mass of air supplied to the reactor per gallon of flow is set unless the AF (slope of the line) is changed.

At the initial startup of a system an AF of 100 is entered until the actual flow and influent BOD5 and TKN concentrations are determined by sampling at which time a different more accurate aeration factor is input; thus changing the rate of response.

The process Air Control dialog touch screen is shown in FIG. 2 below, which shows both the current status and historical information related to the Process Air. It also provides control for process air. Fixed ON and Fixed OFF times are recalculated at the start of a process cycle using the Influent volume of the previous cycle. Influent volume is calculated by multiplying the influent pump rate (gpm) by the run times of the pumps. Process air values will not exceed the provided maximum or minimum ON and OFF times.

The current process cycle is Air Cycle #3. The cycle information is overwritten at the start of a process cycle. The previous cycle as shown in FIG. 2 is Air Cycle #2. The process cycle information shown in Air Cycle #4 in this dialog is from 12:00 PM to 4:00 PM the previous day.

With respect to the Design Pump Rate, the primary parameter required for accurate process air settings is to accurately quantify the flow rate (in gpm) of the pump being monitored by the PLC. The pump rate should be verified at least once per year. The system from which this dialog was obtained uses the raw influent pumps to determine the flow into the system. The discharge rate for these pumps is defined by the value in the “Anoxic Feed Rate” input button in FIG. 2. The title of this button will reflect the pump being used for process air calculations within the program.

With respect to the Aeration Factor: Changing the Aeration Factor changes the rate at which air is supplied to the system. For example, increasing the AF (increasing slope) will increase the amount of air provided per gallon of water and decreasing the AF will decrease the amount of air provided per gallon of water. For example, if you decrease the Aeration Factor from a value of 100 to a value of 90, you will decrease the process air put into the system by 10%.

The Aeration Factor is a value between 1 and 999 and is initially set at 100, representing the design load. See also FIG. 2. It is used by the process to determine the amount of process air to be applied in the next 24 hours to treat the volume of water seen by the plant during the previous ‘cycle’.

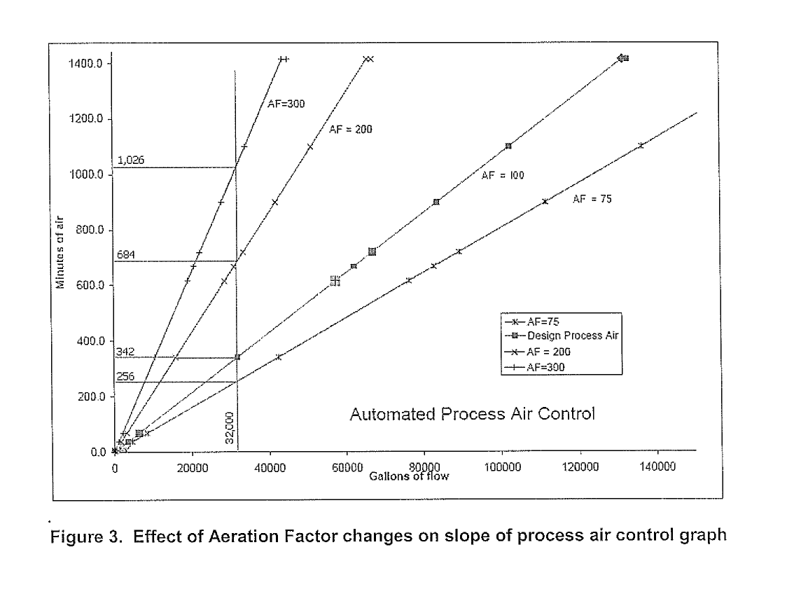

FIG. 3 illustrates how changing the AF affects the amount of air that will be placed into the system. However, increasing the AF above some predetermined high value or below a predetermined minimum value will trigger a notification to verify all inputs and parameters.

Referring back to FIG. 2, the Target Process Air button (see below) represents the total number of minutes of Process Air that will be applied to the process in the next 24 hours. This value is re-calculated at the start of a new process cycle and is determined based on the flow through the system and the time applied during the previous cycle.

Referring back to FIG. 2, specifically the ON and OFF controls, process air is provided to the system by a cycling the blower on and off. These on and off times are called the ON time and OFF time, respectively. Four values are defined within the process to control the calculation of the ON and OFF times. These values are set at startup and are not modified.

Standard ON Time—This value is the standard blower run time (in seconds) that is used for process air. It is NOT the maximum time for process air to be on.
Minimum ON Time.—This value is the minimum blower ON run time (in seconds).
Minimum OFF Time—This is the minimum OFF time (in minutes).
Maximum OFF Time.—This is the maximum OFF time (in minutes).

Process air time (ON/OFF) follows these rules: (a) the minimum and maximum times will never be exceeded, (b) the program will attempt to use the ‘Standard ON Time” by adjusting the OFF times, (c) if the calculated OFF time will exceed the Minimum OFF Time, the ON time will be increased (up 9,999 seconds which is the maximum allowed by the program), and (d) if the OFF time will exceed the Maximum OFF Time, the ON time will be reduced (but will never be less than the Minimum ON Time)

It is understood that the above-described embodiment is merely illustrative of the application. Other embodiments may be readily devised by those skilled in the art which will embody the principles of the invention and fall within the spirit and scope thereof.

We claim:

1. A biological nitrogen removal aeration control process for a wastewater treatment system having an anoxic tank outputting to a biological reactor and outputting from the biological reactor to a clear well, said anoxic tank having an output pipe for anoxic tank effluent, said biological reactor having a top, bottom receiving side, discharge side, two opposite side walls interconnecting the receiving and discharge sides, said top, bottom receiving side, discharge side and side walls defining a biological reactor interior, said biological reactor interior having a filter, an open head-space above the filter, and a sump formed beneath the filter and above the biological reactor bottom, said anoxic tank output pipe connecting to the biological reactor bringing anoxic tank effluent to the biological reactor interior head-space, said biological reactor having a recycle pipe interconnecting the biological reactor interior head-space with the anoxic tank interior, said biological reactor having a discharge pipe interconnecting the biological reactor sump with a clear well interior, comprising the steps:
inserting an end of an air pipe into the biological reactor interior near to the biological reactor top through the biological reactor filter media;
connecting an opposite end of said air pipe to an air source for process air;
controlling said air source by means of a programmable logic controller;
operatively controlling said programmable logic controller with a control panel;
calculating the influent load from the BOD and TKN in the anoxic tank effluent;
determining the biological reactor volume;
calculating an aeration factor which determines the minutes of process air required per gallon of influent load flow;
turning ON the air source pumping process air into the air pipe and aerating the biological reactor for a designated period of time just sufficient for nitrification;
turning OFF the air source for a designated period of time for denitrification;
releasing nitrogen gas formed in the biological reactor through a vent pipe into the atmosphere;
passing a treated wastewater effluent from the biological reactor to the clear well;
recalculating the aeration factor determining the ON and OFF times based on the flow of influent and the air that has already been placed into the biological reactor during a previous cycle;
repeat the steps of turning ON the air source and subsequent steps.

2. The process as recited in claim 1, wherein:
sampling the influent BOD and TKN concentrations as part of recalculating the aeration factor.
